(19) United States
(12) Patent Application Publication
(10) Pub. No.: US 2004/0184464 A1
(43) Pub. Date: Sep. 23, 2004

(54) Data processing apparatus

(75) Inventor: Roger John Holden, Hertfordshire (GB)

Correspondence Address: HAYNES BEFFEL & WOLFELD LLP, P O BOX 366, HALF MOON BAY, CA, 94019, US

(73) Assignee: Airspan Networks Inc., Boca Raton, FL (US)

(21) Appl. No.: 10/391,545

(22) Filed: Mar. 18, 2003

(51) Int. Cl. H04L 12/56

(52) U.S. Cl. 370/395.51

(57) ABSTRACT

A data processing apparatus, and in particular to a data processing apparatus for use in a telecommunications system is disclosed which seeks to provide an improved technique for handling asynchronous events in a synchronous processing environment. The data processing apparatus comprises a data processing unit operable to process data from a synchronous data stream. The data processing apparatus also comprises conversion logic operable to receive an asynchronous event for processing by the data processing unit, the conversion logic being further operable to create event data representing the asynchronous event for transmission in the synchronous data stream. Providing conversion logic which converts an asynchronous event into event data transmissible within the synchronous data stream enables the data processing unit, when operating in a synchronous environment, to handle the asynchronous event in the same manner as any other synchronous data it may receive. Hence, the operation of the data processing unit can be effectively decoupled from the asynchronous event, the occurrence of which may undesirably affect the performance of the data processing unit.

### BACKGROUND OF THE INVENTION

1. Field of the Invention

The present invention relates to a data processing apparatus, and in particular to a data processing apparatus for use in a telecommunications system.

2. Description of the Prior Art

Data processing apparatus are known. One example of such a data processing apparatus is a so-called “synchronous” data processing apparatus. In synchronous data processing apparatus, the operation of elements of the data processing apparatus is co-ordinated with reference to a common clock signal. Also, the supply and processing of data to and between the elements of the data processing apparatus is co-ordinated with reference to the common clock signal, such data often being arranged into a stream of synchronous data for processing by the data processing apparatus. Using synchronous data streams provides a degree of certainty when designing the data processing apparatus since the operation and performance of the data processing apparatus under different situations can be well-defined and controlled.

In real-time data processing apparatus, such as used in telecommunications systems, it is important to ensure that elements of the system will respond within defined time limits when processing the data stream in order to ensure a desired level of service is provided. Accordingly, in such telecommunications systems, real-time data and the processing elements used to process that data are often arranged in a synchronous manner to ensure that the desired level of service is maintained. However, it will be appreciated that in such an interactive environment, events often occur which need to be dealt with by the data processing apparatus, but which can occur at any time and which are not necessarily synchronised with the common clock signal, such events commonly being referred to as so-called “asynchronous” events.

To deal with such asynchronous events in a synchronous apparatus a number of techniques have been developed. One such well-known technique is the use of so-called “interrupts”. Using this approach, when an asynchronous event occurs an interrupt signal is sent, usually over a dedicated control bus, to the data processing apparatus to suspend the processing of the synchronous data stream. This then frees the data processing apparatus to deal with the asynchronous event. Once the data processing apparatus has responded to the asynchronous event then the processing of the synchronous data stream can resume.

However, in real-time data processing apparatus, such as used in telecommunications systems, handling asynchronous events can have a significant impact on the performance of the system. In severe cases, handling asynchronous events can result in real-time synchronous data to be processed by the data processing apparatus being not processed in time and, hence, the data can be lost.

Accordingly, it is an object of the present invention to provide an improved technique for handling asynchronous events in a synchronous processing environment.

### SUMMARY OF THE INVENTION

According to a first aspect of the present invention there is provided a data processing apparatus comprising: a data processing unit operable to process data from a synchronous data stream; and conversion logic operable to receive an asynchronous event for processing by the data processing unit, the conversion logic being further operable to create event data representing the asynchronous event for transmission in the synchronous data stream.

The present invention recognises that not all asynchronous events require servicing by the data processing apparatus immediately and that the processing of these events as they occur can have a significant impact of the performance of the data processing apparatus. Providing conversion logic which converts an asynchronous event into event data transmissible within the synchronous data stream enables the data processing unit, when operating in a synchronous environment, to handle the asynchronous event in the same manner as any other synchronous data it may receive. Hence, the operation of the data processing unit can be effectively decoupled from the asynchronous event, the occurrence of which may otherwise undesirably affect the performance of the data processing unit.

Since the data processing unit can handle the asynchronous event in a synchronous manner, the operation of the data processing apparatus can be more easily predicted and managed irrespective of the unpredictable nature of asynchronous events. Hence, asynchronous events can be readily handled without having a significant impact on the performance of the system and without real-time synchronous data being lost. Accordingly, the data processing apparatus can be managed to respond within defined time limits when processing the data stream and thus a desired level of service can be maintained.

Also, since the data processing apparatus can respond to asynchronous events, the issuer of the asynchronous event can be arranged to operate independently of the data processing apparatus and its operation need not be closely coupled to that of the data processing apparatus. It will be appreciated that this provides significant design flexibility.

Furthermore, by transmitting the event data in the synchronous data stream, asynchronous events can be dealt with by the data processing unit without the need for dedicated paths or buses to transmit signals representing the asynchronous event to the data processing unit. It will be appreciated that in a large data processing apparatus, the routing of such paths or buses can be complex, their provision can involve significant costs, they can also consume significant power and hence any reduction in such complexity is beneficial.

Preferably, there is provided control logic operable to receive and store data for subsequent transmission in the synchronous data stream, the conversion logic being operable to provide the event data to the control logic for subsequent transmission in the synchronous data stream.

By temporarily storing data (e.g. in buffers), the organisation and timing of the synchronous data stream can be managed and predetermined data easily inserted when required. Also, storing the data ensures that the data is not lost but can instead be retained until a convenient time when it may then be transmitted in the synchronous data stream.

Preferably, the control logic has buffer logic operable to store synchronous data representing synchronous events and to store the event data.

Accordingly, both synchronous and asynchronous data is stored by the control logic, both of which can be selected thereafter for transmission in the synchronous data stream.

Preferably, the control logic has queue logic operable to provide a plurality of queues containing a number of queue pointers identifying locations of the data stored in the buffer logic.

Providing queue pointers to point to locations of stored data provides an efficient way of handling that data since the pointers can easily be transferred between elements of the data processing apparatus without needing to transfer data itself.

Preferably, at least one queue is provided containing pointers to the synchronous data and at least one further queue is provided containing pointers to the event data.

Providing queues for synchronous data and event data ensures that each type of data can be controlled and handled separately in accordance with any specific requirements specific to that data.

In preferred embodiments, the synchronous data is attributed a higher priority than the event data.

Attributing a priority with data in the buffer organises the data in a predetermined order based on the importance of the data. By attributing a higher priority to the synchronous data, the likelihood of this data being transmitted over the synchronous data stream is increased. Equally, it will be appreciated that by attributing the event data with a lower priority, the likelihood of this event data preventing critical synchronous data from being transmitted within a required timeframe can be reduced.

In preferred embodiments, interface logic is provided which is operable to retrieve data from the control logic for transmission to the data processing unit in the synchronous data stream.

Accordingly, the interface logic can control and co-ordinate the retrieval and subsequent transmission of any data over the synchronous data stream.

In preferred embodiments, the interface logic is operable to transmit data in the synchronous data stream having regard to the priority attributed to the data.

Hence, the interface logic is responsive to the priority attributed to the data and can retrieve and transmit that data in dependence on that priority. Accordingly, the interface logic may be arranged to transmit higher priority data in preference to lower priority information by, for example, transmitting higher priority data more frequently than lower priority data.

In preferred embodiments, the interface logic comprises a first element operable to transmit the synchronous data in the synchronous data stream and a second element operable to transmit the event data in the synchronous data stream.

By providing different elements for the synchronous data and event data, the elements can operate independently of each other and the different data types can be handled separately.

In preferred embodiments, the first element is operable to transmit the synchronous data in the synchronous data stream by polling the at least one queue to retrieve a queue pointer and transmitting the synchronous data stored in the buffer logic at a location indicated by the queue pointer and the second element is operable to transmit the event data in the synchronous data stream by polling the at one further queue to retrieve a queue pointer and transmitting the event data stored in the buffer at a location indicated by the queue pointer.

In preferred embodiments, a first rate of polling by the first element and a second rate of polling by the second element is set in dependence on the priority attributed to the synchronous data and the event data.

Accordingly, by polling at a rate which has regard to the priority ensures that data is transmitted having regard to that priority. In preferred embodiments, the rate of polling associated with the synchronous data is higher than the rate of polling associated with the event data.

It will be appreciated that it would be possible to determine dynamically the amount of spare capacity which may exist after transmitting higher priority data which may then be utilised for transmitting lower priority level data and to alter the rates of polling accordingly. By transmitting lower priority level data only in the available bandwidth, the transmission of this data can be achieved without interrupting the transmission of more critical data. Also, it will be appreciated that utilising this available bandwidth helps to smooth out undesirably large fluctuations in the data transmission utilisation and helps to ensure a reasonably constant rate of data transmission. However, in preferred embodiments, the rates of polling are set at system level having regard to typical data flows.

It will be appreciated that the synchronous data stream may be transmitted over a data bus which has a particular bandwidth. The synchronous data stream may be comprised of different data stream components, such as synchronous data and event data, each of which will have a particular data rate and will require a corresponding portion of the bandwidth of the data bus. Hence, for any particular bandwidth, the control logic could be arranged to determine whether, after transmitting the higher priority data, any spare capacity in the bandwidth exists for transmitting lower priority data.

Different techniques exist to enable multiple data stream components to be transmitted over a data bus. One technique is to assign a number of lines of the data bus to different data stream components in dependence on the data rate of those components. Hence, the number of lines supporting higher priority data could be varied to support the data rate of that data, whilst the remaining lines could then be assigned to support lower priority data. Another technique is a time-division multiplexing approach, whereby data is transmitted over the data bus in time-slots and the bandwidth assigned to each data stream component can be varied by varying the frequency of time slots available to that data stream component. Hence, the number of time slots available for higher priority data would be set to be larger than that available for lower priority data.

By ensuring that high priority data level is transmitted in preference to low priority level data, it can be ensured that the most critical data is likely to be provided to the data processing unit. Such high priority level data is likely to be real-time or time-critical data which needs to be processed within a particular time period otherwise processing errors can occur or a desired level of service to a user or customer is not achieved.

In preferred embodiments, the synchronous data stream is operable to support transmission by only one element at any one time.

Accordingly, a time-division-type technique is utilised for transmission of the data over the synchronous data stream.

In preferred embodiments, each element is operable to generate a request when seeking to transmit data in the synchronous data stream and the data processing apparatus further comprises an arbiter operable to receive the requests and to grant access to transmit in the synchronous data stream to one of the elements in response to the requests.

By providing an arbiter, a strict time-division allocation need not be provided. Instead, when each element requires to transmit in the synchronous data stream it may request access to the synchronous data stream. On the next appropriate available slot, the arbiter will then grant the element access to the synchronous data stream to transmit the data. It will be appreciated that this approach provides additional flexibility.

In preferred embodiments, the data processing unit is a modem.

It will be appreciated that in order to ensure that no data is lost, the modem should receive data at a rate no greater than that which it can transmit. If the form in which the data received by the modem is larger than that in which it is to be transmitted (e.g. if the modem employs some form of compression or if some header or control information associated with the data is removed by the modem before transmission) then clearly the bandwidth of received data can be larger than the transmission bandwidth. Conversely, if the form in which the data received by the modem is smaller than that in which it is to be transmitted (e.g. if the modem employs some form of decompression or if some header or control information associated with the data is added by the modem before transmission) then clearly the bandwidth of received data would be smaller than the transmission bandwidth.

In preferred embodiments the conversion logic comprises a processor operable to generate the asynchronous event.

As mentioned above, since the data processing apparatus can respond to asynchronous events, the operation of the processor does not need to be closely coupled to that of the data processing apparatus. Instead, the processor can simply issue an asynchronous event at a time convenient to the processor and this event will then be serviced by the data processing apparatus in due course.

Preferably, the data and the event data each comprise data packets and the control logic comprises a plurality of buffers, each buffer being operable to store a data packet to be transmitted in the synchronous data stream; at least one connection queue associated with the synchronous data stream, the connection queue being operable to store one or more queue pointers, each queue pointer being associated with a data packet by providing an identifier for the buffer containing the data packet; and transmission logic responsive to the connection queue to transmit data packets in the synchronous data stream.

A plurality of buffers is provided for storing data packets to be passed over the synchronous data stream. However the data packets themselves need not passed between various elements of the conversion logic, control logic or transmission logic within the data processing apparatus. Instead, a connection queue is provided associated with the synchronous data stream. The connection queue is operable to store one or more queue pointers, with each queue pointer being associated with a data packet by providing an identifier for the buffer containing that data packet.

With this approach, the transmission logic is responsive to the receipt of a queue pointer from the associated connection queue to perform transmission of the associated data packet. Thus, the passing of a data packet over the synchronous data stream is controlled by the routing of the associated queue pointer to the transmission logic. Since the queue pointers are significantly smaller in size than the data packets in the buffers to which they refer, then such an approach significantly reduces the bandwidth required for the connections between the various elements, thus enabling a significant reduction in the size and cost of the data processing apparatus.

Preferably, each buffer is operable to store a data packet and one or more control fields for storing control information relating to that data packet.

Preferably, a plurality of data processing units are operable to process data from the synchronous data stream and the data packet includes a header portion comprising an indication of which of the plurality of data processing units is to process that data packet.

Preferably, the asynchronous event is a command for a data processing-unit.

The command may be a request for management data (such as, for example, status or statistics or configuration data) or may provide some other control function which does not generate any data in response.

Viewed from a second aspect, the present invention provides in a data processing apparatus comprising a data processing unit operable to process data from a synchronous data stream, a method of transmitting asynchronous events, the method comprising the steps of: receiving an asynchronous event for processing by the data processing unit; and creating event data representing the asynchronous event for transmission in the synchronous data stream.

### BRIEF DESCRIPTION OF THE DRAWINGS

The present invention will be described further, by way of example only, with reference to a preferred embodiment thereof as illustrated in the accompanying drawings, in which:

FIG. 1 is a block diagram illustrating a data processing apparatus in accordance with one embodiment of the present invention;

FIG. 2 is a diagram schematically illustrating both the downlink and uplink data flow in accordance with one embodiment of the present invention;

FIG. 3 illustrates the format of a buffer;

FIG. 4 illustrates the format of a queue pointer;

FIG. 5 illustrates the format of a buffer command;

FIG. 6 illustrates the format of a queue command;

FIG. 7 illustrates the arrangement of buses within the client-server structure provided within the SoC of one embodiment of the present invention;

FIG. 8 is a timing diagram for a buffer access in accordance with one embodiment of the present invention;

FIG. 9 is a timing diagram of a queue access in accordance with one embodiment of the present invention;

FIGS. 10A and 10B are flow diagrams illustrating the processing of commands within the system processor and the comsta logic, respectively, illustrated in FIG. 1;

FIGS. 11A and 11B are flow diagrams illustrating the processing performed within the comsta logic and the system processor. respectively, of FIG. 1 in order to process status information; and

FIG. 12 is a diagram providing a schematic overview of an example of a wireless telecommunications system in which the present invention may be employed.

### DESCRIPTION OF A PREFERRED EMBODIMENT

For the purposes of describing a data processing apparatus of an embodiment of the present invention, an implementation in a wireless telecommunications system will be considered. Before describing the preferred embodiment, an example of such a wireless telecommunications system in which the present invention may be employed will first be discussed with reference to FIG. 12.

FIG. 12 is a schematic overview of an example of a wireless telecommunications system. The telecommunications system includes one or more service areas 12, 14 and 16, each of which is served by a respective central terminal (CT) 10 which establishes a radio link with subscriber terminals (ST) 20 within the area concerned. The area which is covered by a central terminal 10 can vary. For example, in a rural area with a low density of subscribers, a service area 12 could cover an area with a radius of 15-20 Km. A service area 14 in an urban environment where there is a high density of subscriber terminals 20 might only cover an area with a radius of the order of 100 m. In a suburban area with an intermediate density of subscriber terminals, a service area 16 might cover an area with a radius of the order of 1 Km. It will be appreciated that the area covered by a particular central terminal 10 can be chosen to suit the local requirements of expected or actual subscriber density, local geographic considerations, etc, and is not limited to the examples illustrated in FIG. 12. Moreover, the coverage need not be, and typically will not be circular in extent due to antenna design considerations, geographical factors, buildings and so on, which will affect the distribution of transmitted signals.

The wireless telecommunications system of FIG. 12 is based on providing radio links between subscriber terminals 20 at fixed locations within a service area (e.g., 12, 14, 16) and the central terminal 10 for that service area. These wireless radio links are established over predetermined frequency channels, a frequency channel typically consisting of one frequency for uplink signals from a subscriber terminal to the central terminal, and another frequency or downlink signals from the central terminal to the subscriber terminal. As shown in FIG. 12, the CTs 10 are connected to a telecommunication network 100 via backhaul links 13, 15 and 17. The backhaul links can use copper wires, optical fibres, satellites, microwaves, etc.

Due to bandwidth constraints, it is not practical for each individual subscriber terminal to have its own dedicated frequency channel for communicating with a central terminal. Hence, techniques have been developed to enable data relating to different wireless links (i.e. different ST-CT communications) to be transmitted simultaneously on the same frequency channel without interfering with each other. One such technique involves the use of a “Code Division Multiple Access” (CDMA) technique whereby a set of orthogonal codes may be applied to the data to be transmitted on a particular frequency channel, data relating to different wireless links being combined with different orthogonal codes from the set. Signals to which an orthogonal code has been applied can be considered as being transmitted over a corresponding orthogonal channel within a particular frequency channel.

One way of operating such a wireless telecommunications system is in a fixed assignment mode, where a particular ST is directly associated with a particular orthogonal channel of a particular frequency channel. Calls to and from items of telecommunications equipment connected to that ST will always be handled by that orthogonal channel on that particular frequency channel, the orthogonal channel always being available and dedicated to that particular ST. Each CT 10 can then be connected directly to the switch of a voice/data network within the telecommunications network 100.

However, as the number of users of telecommunications networks increases, so there is an ever-increasing demand for such networks to be able to support more users. To increase the number of users that may be supported by a single central terminal, an alternative way of operating such a wireless telecommunications system is in a Demand Assignment mode, in which a larger number of STs are associated with the central terminal than the number of traffic-bearing orthogonal channels available to handle wireless links with those STs, the exact number supported depending on a number of factors, for example the projected traffic loading of the STs and the desired grade of service. These orthogonal channels are then assigned to particular STs on demand as needed. This approach means that far more STs can be supported by a single central terminal than is possible in a fixed assignment mode. In one embodiment of the present invention, each subscriber terminal 20 is provided with a demand based access to its central terminal 10, so that the number of subscribers which can be serviced exceeds the number of available wireless links.

However, the use of a Demand Assignment mode complicates the interface between the central terminal and the switch of the voice/data network. To avoid each central terminal having to provide a large number of interfaces to the switch, an Access Concentrator (AC) may be provided between the central terminals and the switch of the voice/data network within the telecommunications network 100, which transmits signals to, and receives signals from, the central terminal using concentrated interfaces, but maintains an unconcentrated interface to the switch, protocol conversion and mapping functions being employed within the access concentrator to convert signals from a concentrated format to an unconcentrated format, and vice versa.

It will be appreciated by those skilled in the art that, although an access concentrator can be embodied as a separate unit to the central terminal 10, it is also possible that the functions of the access concentrator could be provided within the central terminal 10 in situations where that was deemed appropriate.

For general background information on how the AC, CT and ST may be arranged to communicate with each other to handle calls in a Demand Assignment mode, the reader is referred to GB-A-2,367,448.

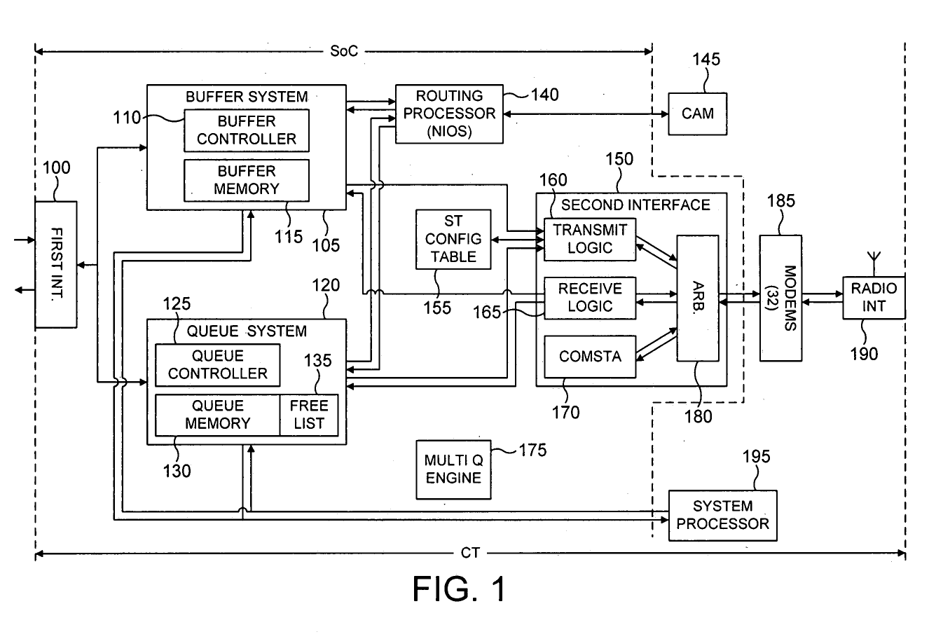

FIG. 1 is a block diagram illustrating components that may be provided within a central terminal 10 in accordance with one embodiment of the present invention, and in particular illustrates the components provided within a data processing apparatus, for example a SoC, within the central terminal in order to manage the passing of data packets between a first interface 100 and a second interface 150. In the embodiment illustrated in FIG. 1, the first interface 100 is coupled to the telecommunications network 100 via a backhaul link, data packets being passed over that backhaul link using a first transport mechanism. In one embodiment the first transport mechanism is an Ethernet transport mechanism operable to transport data as Ethernet data packets.

In contrast, the second interface 150 is connectable to further logic within the central terminal, which employs a second transport mechanism. In the embodiment illustrated in FIG. 1, a proprietary transport mechanism is used that is operable to segment data packets into a number of frames, with each frame having a predetermined duration and comprising a header portion, and a data portion of variable data size. In one embodiment, the second transport mechanism is a Block Data Mode (BDM) transport mechanism as described for example in UK patent application GB-A-2,367,448. In accordance with the BDM transport mechanism, the header portion is arranged to be transmitted in a fixed format chosen to facilitate reception of the header portion by each subscriber terminal within the telecommunications system using that transport mechanism, and is arranged to include a number of control fields for providing information about the data portion. The data portion is arranged to be transmitted in a variable format selected based on certain predetermined criteria relevant to the particular subscriber terminal to which the data portion is destined, thereby enabling a variable format to be selected which is aimed at optimising the efficiency of the data transfer to or from the subscriber terminal.

Whilst an embodiment of the present invention will be described assuming that the first transport mechanism is an Ethernet transport mechanism, and the second transport mechanism is the above mentioned BDM transport mechanism, it will be appreciated that the present invention is not limited to any particular combination of transport mechanisms, and instead the routing techniques of the present invention may be applied to pass data packets between first and second interfaces coupled to different transport mechanisms.

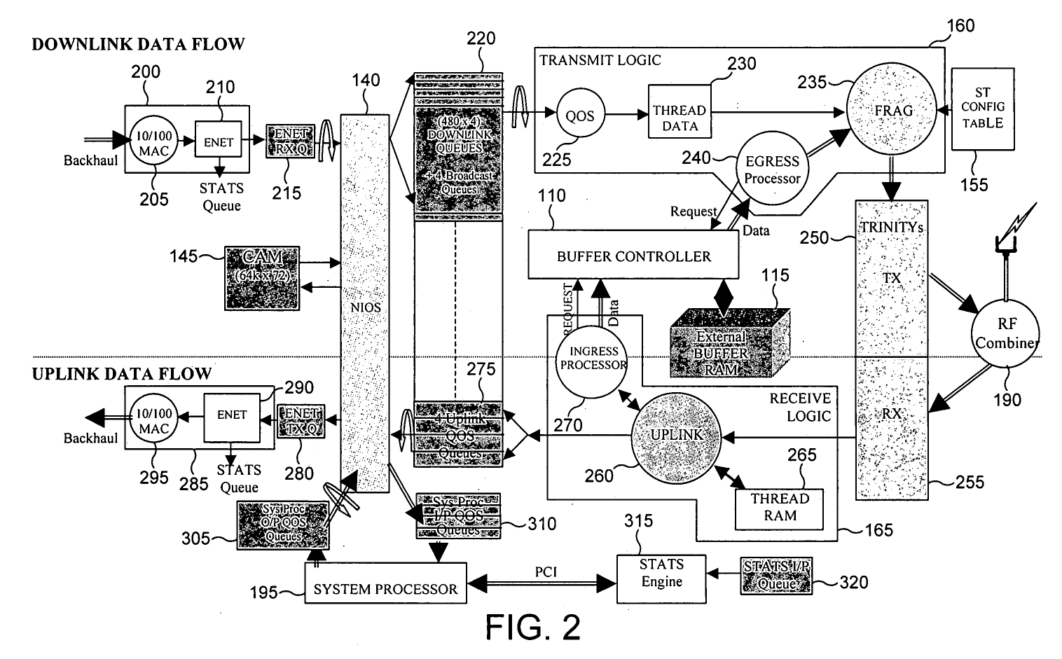

As shown in FIG. 1, the SoC includes a buffer system 105 within which is provided a buffer controller 110 and a buffer memory 115, and a queue system 120 within which is provided a queue controller 125 and a queue memory 130. Although for ease of illustration the buffer memory 115 and queue memory 130 are shown as being within the SoC, they can instead be provided off-chip, and typically would be provided off-chip if it were considered infeasible (e.g. too expensive due to their size) to incorporate them on-chip. The buffer controller 10 is used to control accesses to the buffers within the buffer memory 115, and similarly, the queue controller 125 is used to control accesses to queues within the queue memory 130. As will be discussed in more detail later, part of the queue memory 130 is used to contain a free list 135 identifying available buffers within the buffer memory 115. When a data packet is received by the first interface 100, or indeed by the second interface 150, then a buffer within the buffer memory 115 is identified with reference to the free list 135, and that data packet is then placed within the identified buffer. As will then be discussed in more detail with reference to FIG. 2, a plurality of connection queues within the queue memory 130 are provided which are associated with various connections between the processing elements within the SoC, and each connection queue can store one or more queue pointers, with each queue pointer being associated with a data packet by providing an identifier for the buffer containing that data packet.

Accordingly, when the received data packet is placed within the selected buffer, a corresponding queue pointer will be placed in an appropriate connection queue from where it will subsequently be retrieved by the relevant processing element, for example the routing processor 140. When that processing element has performed predetermined control functions in relation to the data packet identified by the queue pointer, the queue pointer will be moved into a different connection queue from where it will be received by a next processing element within the SoC. Accordingly, as will be discussed in more detail with reference to FIG. 2, the passing of a data packet between the first and second interfaces is controlled by the routing of an associated queue pointer between a number of connection queues.

One of the processing elements required to perform predetermined functions to control the routing of a data packet between the first and second interfaces is the routing processor 140, also referred to herein as the NIOS. The routing processor 140 has access to a Contents Addressable Memory (CAM) 145 which is used to associate destination addresses with subscriber terminals, and is referenced by the routing processor 140 as and when required. Whilst the CAM 145 could be provided on the SoC, it can alternatively, as illustrated in FIG. 1, be provided externally to the SoC.

The second interface 150 incorporates transmit logic 160 for outputting data packets via an arbiter logic unit 180 within the second interface 150 to a set of modems 185 within the central terminal, and receive logic unit 165 for receiving and reconstituting data packets received in segmented form from one or more modems within the set of modems 185, again via the arbiter logic unit 180. For downlink communications, the modems are arranged to convert the input signal into a form suitable for radio transmission from the radio interface 190, whilst for uplink communications, the modems 185 are arranged to convert the received radio signal into a form for onward transmission to the receive logic unit 165 within the SoC.

Also provided within the SoC is a MultiQ engine 175 used to keep track of the processing of a data packet within the SoC in situations where that data packet is to be sent to multiple destinations, and accordingly there are multiple queue pointers associated with the buffer in which that data packet is stored. The functionality of the MulitQ engine will be described in more detail later.

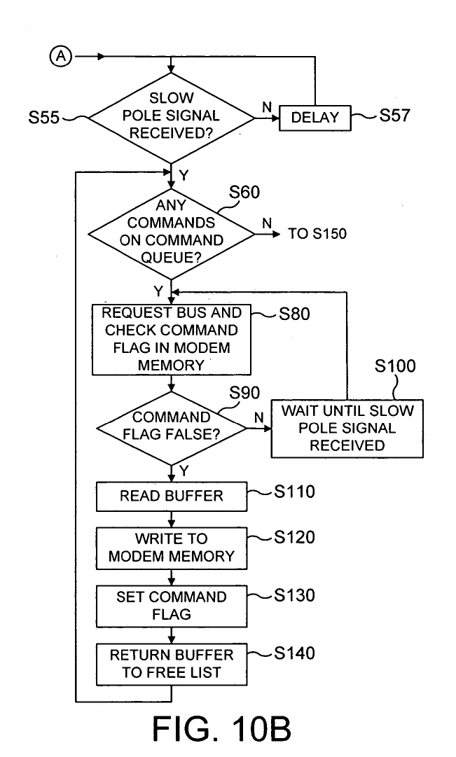

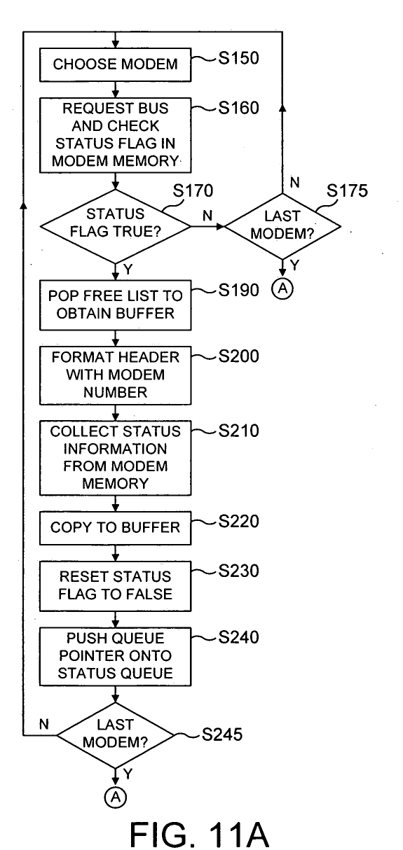

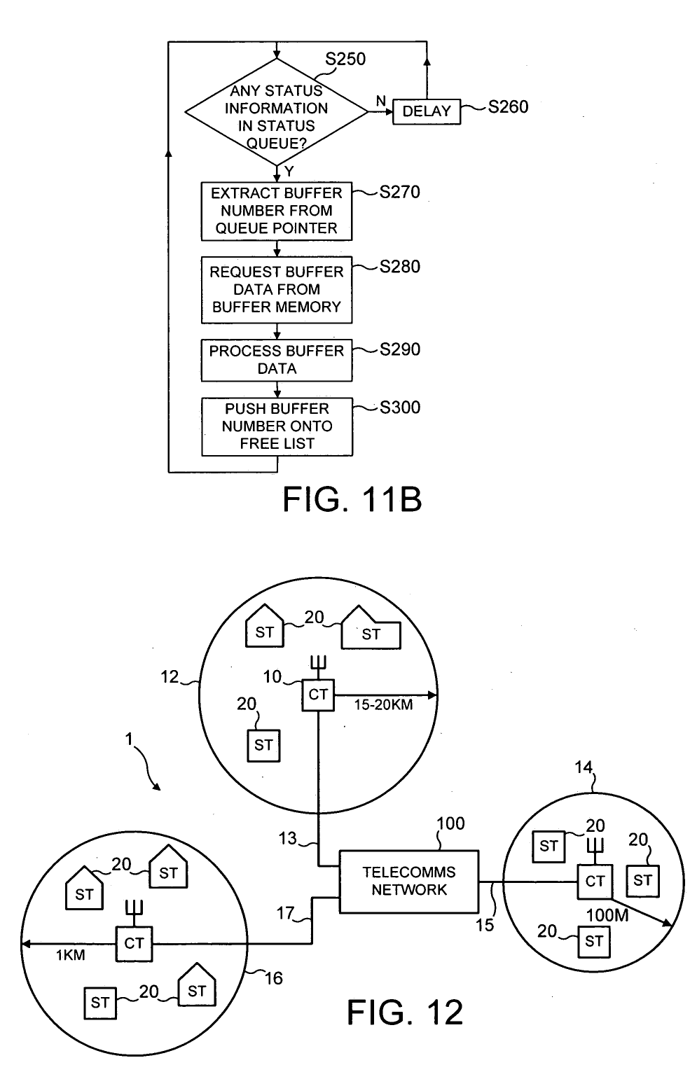

Also provided within the central terminal is a system processor 195 and, within the SoC, a ComSta logic unit 170. The system processor 195 is typically a relatively powerful processor which is provided externally to the SoC, and is arranged to perform a variety of control functions. One particular function that can be performed by the system processor 195 is the issuance of commands requesting status information from the modems 185, this process being managed by the placement of the relevant data identifying the command within an available buffer of the buffer memory 115, and the placement of the corresponding queue pointer within a connection queue associated with the ComSta logic unit 170. The ComSta unit 170 is then responsible for issuing the command to the modem, and receiving any status information back from the modem. When status information is received by the ComSta unit 170, it places the status information within an available buffer of the buffer memory 115 and places a corresponding queue pointer within a connection queue accessible by the system processor 195, from where that status information can then be read by the system processor. More details of the operation of the system processor 195 and of the ComSta logic unit 170 will be provided later with reference to the flow diagrams of FIGS. 10 and 11.

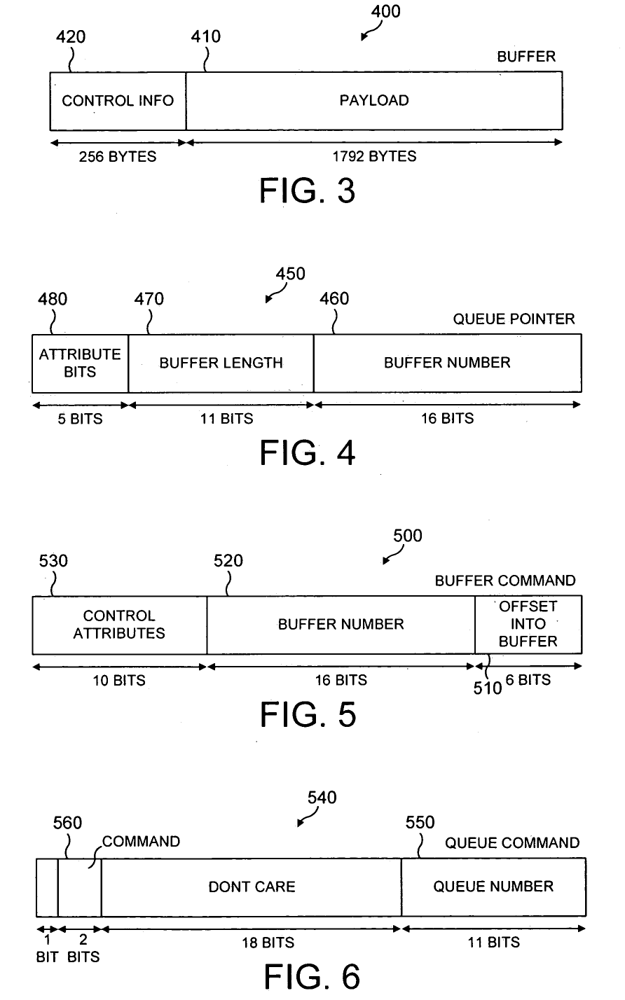

As mentioned earlier, each of the processing elements is arranged to access a buffer by issuing a buffer command to the buffer controller 110. An example of the format of a buffer used in one embodiment of the present invention is illustrated in FIG. 3. As shown in FIG. 3, the buffer 400 has a size of 2048 bytes, with the first 256 bytes being reserved for control information 420. Hence, 1792 bytes are available for the actual data payload 410. It will be appreciated that the number of such buffers provided within the buffer memory 15 is a matter of design choice, but in one embodiment there are 65000 buffers within the buffer memory 115. In one embodiment, the buffer is formed from external SDRAM.

A variety of different control information can be stored within the control information block 420. In one embodiment, the control information 420 may identify an uplink session identifier giving an indication of the subscriber terminal from which an uplink data packet is received, and may include certain insertion data for use in transmitting a data packet, for example a VLAN ID. Furthermore, in one embodiment where the MultiQ engine 175 is used, the control information 420 may include MultiQ tracking information whose use will be describer later.

To access a buffer 400, a processing element needs to issue a buffer command to the buffer controller 110, in one embodiment the buffer command taking the form illustrated in FIG. 5. As can be seen from FIG. 5, the buffer command 500 includes a number of bits 510 specifying an offset into the buffer, in one embodiment 6 bits being allocated for this purpose. Hence, in the example where each buffer is 2048 bytes long, this enables a particular 32 byte portion of the buffer to be specified.

A second portion 520 of the buffer command, in the embodiment illustrated in FIG. 5 this second portion being comprised of 16 bits, provides a buffer number identifying the particular buffer within the buffer memory 115 the subject of the buffer command. Finally, a third portion 530 specifies certain control attributes, in FIG. 5 this third portion consisting of 10 bits. This control attribute region 530 will include an attribute identifying whether the processing element issuing the buffer command wishes to write to the buffer, or read from the buffer. In addition, the control attributes may specify certain client burst buffers, from which data to be stored in the buffer is to be read or into which data retrieved from the buffer is to be written.

In a similar manner to that described above in relation to buffers, if a processing element wishes to access a queue within the queue memory 130 in order to place a queue pointer on the queue, or read a queue pointer from the queue, then it will issue a queue command to the queue controller 125. In one embodiment, each queue pointer is as illustrated in FIG. 4. Hence, each queue pointer 450 is in that embodiment 32 bits in length, and has a first region 460 specifying a buffer number, thereby indicating the buffer with which that queue pointer is associated. A second region 470 of the queue pointer 450 specifies a buffer length value, this giving an indication of the length of the data packet within the buffer. Finally, a third region 480 contains a number of attribute bits, and in one embodiment these attribute bits include a bit indicating whether this queue pointer is part of a MultiQ function, and another bit indicating whether an insert or strip process needs to be performed in relation to the buffer associated with the queue pointer. In the embodiment illustrated in FIG. 4, the buffer number is specified by the first 16 bits, the buffer length by the next 11 bits, and the attribute bits by the final 5 bits.

Each queue within the queue memory 130 is capable of containing a plurality of such queue pointers. In one embodiment, some connection queues are arranged to hold up to 32 queue pointers, whilst other connection queues are arranged to hold up to 64 queue pointers. In addition, in one embodiment, a final queue is used to contain the free list 135, and can hold up to 65000 32-bit entries.

The queue command used in one embodiment to access queue pointers is illustrated in FIG. 6. Here, the queue command 540 includes a first region 550 specifying a queue number, in this embodiment the queue number being specified by 11 bits. A second region 560 then specifies a command value, which in one embodiment will specify whether the processing element issuing the queue command wishes to push a queue pointer onto the queue, or pop a queue pointer from the queue. Each queue can be set up in a variety of ways, but in one embodiment the queues are arranged as First-In-First-Out (FIFO) queues.

Having now described the format of the buffers, buffer commands, queue pointers and queue commands used in one embodiment of the present invention, a further discussion of the flow of data through the data processing apparatus of FIG. 1 will now be provided with reference to FIG. 2. Considering first the downlink data flow, an Ethernet data packet will be received by reception logic 200 within the first interface 100 (FIG. 1), where MAC logic 205 and an external Physical Interface Unit (PHY) (not shown) are arranged to interface the 10/100T port to the Ethernet receiving logic 210. When the data packet is received by the Ethernet receiving logic 210, it will issue a queue command to the queue controller 125 in order to pop the free list queue 135, as a result of which a queue pointer will be retrieved identifying a free buffer within the buffer memory 115. A series of buffer-commands will then be issued by the reception logic 200 to the buffer controller 110, to cause the data packet to be stored in the identified buffer within the buffer memory 115. This connection is not shown in FIG. 2. In addition, the Ethernet receiving logic 210 will issue a further queue command to the queue controller 125 to cause a queue pointer identifying the buffer location together with its packet length to be put into a preassigned queue 215 for Ethernet received packets. In addition, as schematically illustrated in FIG. 2, the Ethernet receiving logic 210 may be arranged to issue a further queue command to the queue controller to cause a queue pointer to be placed on a stats queue 320 that will in turn cause the stats engine 315 to update information within the memory of the system processor 195.

The NIOS 140 will periodically poll the Ethernet receive queue 215 by issuing a queue command to the queue controller 125 requesting that a queue pointer be popped from that queue 215. When the NIOS 140 receives the queue pointer, it will obtain the buffer number from that queue pointer and will then read the appropriate header fields of the data packet residing in that buffer in order to extract certain header information, in particular the destination and any available QOS information. These header fields will be the actual fields within the Ethernet data packet, and accordingly will be contained within the payload portion 410 of the relevant buffer 400. The NIOS 140 is then arranged to access a CAM 145 to perform a look up process based on that header information in order to obtain the identity of the subscriber terminal, and its priority level for the received packet. The NIOS 140 is then arranged to issue a queue command to the queue controller to cause the queue pointer to be placed in an appropriate one of the downlink queues 220 associated with that subscriber terminal and its priority (QOS) level.

If an entry in the CAM is not present for the input header information, then that data packet can be forwarded via the I/P QOS queues 310 to the system processor 195 for handling. This may result in the data packet being determined to be legitimate data traffic, and hence the system processor may cause an entry to be made in the CAM 145, whereby that routing and/or QOS information will be available in the CAM 145 for subsequent reference when the next data packet being sent over that determined path is received. Alternatively the system processor may determine that the data traffic does not relate to legitimate data traffic (for example if determined to be from a hacking source), in which event it can be rejected.

In the event that the system processor makes an entry in the CMA 145, it is arranged in one embodiment to reissue the queue pointer for the relevant data packet to the NIOS via the system processor I/P QOS queues 305. When the NIOS reprocesses the queue pointer, it will now find a hit in the CAM 145 for the header information, and so can cause the queue pointer to be placed in the appropriate downlink connection queue 220.

The downlink data will be transmitted via the transmit modems 250 (the transmit modems 250 and the receive modems 255 collectively being referred to herein as the Trinity modems) and the RF combiner 190 to the relevant subscriber terminal on up to 15 orthogonal channels, in 4 ms bursts (at 2.56 Mchips/s). This is known as the BDM period. Packets are smeared across as many orthogonal channels as possible such that the maximum amount possible of the packet is sent in a given BDM time period. Any part of the packet remaining will be transmitted in the next period. This is achieved by forming separate packet streams known as “threads” to stream the data across the available orthogonal channels. A “thread” can hence be viewed as a packet that has started but not finished.

The QOS engine 225 within the transmit logic 160 is arranged to periodically poll the downlink queues 220 by issuing the appropriate queue commands to the queue controller 125 seeking to pop queue pointers from those queues. Its purpose is to poll the downlink queues in a manner which will ensure that the appropriate priority is given to the downlink data based on that data's QOS level, and hence will be arranged to poll higher QOS level queues more frequently than lower QOS level queues. As a result of this process, the QOS can form threads for storing as thread data 230, which are subsequently read by the FRAG engine 235. The FRAG engine 235 then fragments the thread data 230 into data bursts of BDM period. During this process, it employs an EGRESS processor 240 to interface to the buffer RAM 115 via the buffer controller 110 so that modification of the data packets extracted from the relevant buffers can be carried out whilst forwarding on to the transmit modems 250 (such modification may for example involve insertion or modification of VLAN headers).

Once the data retrieved from the buffer RAM 115 has been written to transmit buffers within the transmit modems 250, it then sends that data via the RF combiner 190 to the subscriber terminals. When a particular thread terminates (i.e. because its associated buffer is now empty), the buffer number is then pushed back onto the free list by issuance of the appropriate queue command to the queue controller 125.

Considering now the uplink data flow, the data is received by the RF combiner 190 as a burst every 4 ms BDM period (at 2.56 Mchips/sec). This data is placed in a receive buffer within the receive modems 255, from where it is then retrieved by the uplink engine 260 of the receive logic 165.

The receive logic includes a thread RAM 265 for storing control information used in the receiving process. In particular, the control information comprises context information for every possible uplink connection. In one particular embodiment envisaged by FIG. 2, there are 480 possible session identifiers that can be allocated to uplink connections, each having a normal or an expedited mode, thereby resulting in 960 possible uplink connections or threads. The thread RAM 265 has an entry for each such thread, specifying the buffer number used for that thread, the current size of data in the buffer (in bytes), and an indication of the state of the recombination of the received bursts or segments by the uplink engine 260 of the receive logic 165. As an example of such a recombination indication, the indication may indicate that the uplink engine is idle, that it has processed a first burst, that it has processed a middle burst, or that it has processed an end burst.

Hence, when the uplink engine 260 retrieves a first burst of data for a particular data packet from the receive modems, it issues a queue command to the queue controller 125 to cause an available buffer to be popped from the free list 135. Once the buffer has been identified in this manner, the uplink engine causes that buffer number to be added in the appropriate entry of the thread RAM 265.

In addition it will pass the buffer number to the ingress processor 270 along with the current burst of data received. The ingress processor 270 will then issue a buffer command to the buffer controller 110 to cause that data to be written to the identified buffer. The ingress processor 270 will also cause the session ID associated with the subscriber terminal from which the data has been received to be written into the control information field 420 of the buffer.

In one embodiment, the buffer memory 115 has to be written to in blocks of 32 bytes aligned on 32 byte boundaries. The ingress processor takes this into account when generating the necessary buffer command(s) and associated buffer data, and will “pad” the data as necessary to ensure that the data forms a number of 32 byte blocks aligned to the 32 byte boundaries.

When this is done, the uplink processor will cause the recombination indication in the relevant context thread of the thread RAM to be set to show that the first burst has been processed, and will also cause the number of bytes stored in the identified buffer to be added to that context in the thread RAM 265.

When the uplink engine 260 retrieves the next burst for the data packet from the modems 255, and passes it on to the ingress processor, then if the last 32 byte block of data sent to the buffer RAM for the previous burst of that data packet was padded, the ingress processor will cause that data block to be retrieved from the buffer and for the padded bits to be replaced with the corresponding number of bits from the “real” data now received.

Again, when the ingress processor has stored this new burst of data, the uplink processor will cause the recombination indication in the relevant context thread of the thread RAM to be set to show that a middle burst has been processed, and will also cause the total number of bytes now stored in the identified buffer to be updated in the thread RAM 265.

When the last burst of data has been retrieved by the uplink engine 260 (as indicated by an end marker in the burst of data), that data has been stored to the buffer via the ingress processor 270, and the relevant context thread has been updated, then the uplink engine 270 is operable to issue a queue command to the queue controller 125 to cause a queue pointer to be pushed onto one of the four uplink QOS queues 275. The QOS level to be associated with the received data packet will be set by the subscriber terminal and so will be indicated in the header of each burst received from the modems. Hence, the uplink engine can obtain the required QOS level from the header of the last burst of the data packet received, and use that information to identify which uplink QOS queue the queue pointer should be placed upon.

Whilst in preferred embodiments there are four possible QOS levels, and accordingly four uplink QOS queues 275, it will be appreciated that the number of QOS levels in any particular embodiment may be greater or less than four, and the number of uplink QOS queues will be altered accordingly.

In addition to causing a queue pointer to be placed on one of the uplink QOS queues 275, the uplink engine may also cause a pseudo queue pointer to be placed on the stats I/P queue 320.

If any packet segments are lost or get out of sequence, then an error is detected by the receive logic 165, and the buffer currently in progress is discarded, either by overwriting it with new data or by returning it to the free list.

The NIOS 140 is arranged to periodically poll the uplink QOS queues 275 by issuing an appropriate queue command to the queue controller 125 requesting a queue pointer to be popped from the identified queue. When a queue pointer is popped from the queue, the NIOS reads the buffer number from the queue pointer and retrieves the Session ID from the buffer control information field 420. Optionally part of the packet header may also be retrieved from the buffer. This information is used for lookups in the CAM 145 that determine where the data packet is to be routed and what modifications to the data packet (if any) are required. The session If) is used to check the validity of the data packet (i.e. to check whether that ST is currently known by the system). The queue pointer is then pushed into the Ethernet transmit queue 280 via issuance of the appropriate queue command from the NIOS 140 to the queue controller 125.

The Ethernet transmit engine 290 within the transmission logic 285 of the first interface 100 periodically polls the Ethernet transmit queue 280 by issuance of the appropriate queue command to the queue controller, and when a queue pointer is popped from the queue, it uses an EGRESS processor to interface to the identified buffer, so that any required packet modification (e.g. insertion or modification of VLAN headers) can be carried out prior to output of the data packet over the backhaul link. The data is then passed from the Ethernet transmit logic 290 via the MAC logic 295 to the external PHY (not shown), prior to issuance of the data packet over the backhaul. The Ethernet transmit logic 290 is also able to output a queue pointer to a statistics queue 320 accessible by the STATS engine 315, that will in turn cause the stats engine 315 to update information within the memory of the system processor 195. Once it has been determined that the packet has been transmitted successfully (in preferred embodiments this being done with reference to checking of the MAC transmit status within the MAC logic 295, the buffer that contained the data is released to the free list.

Statistics gathered from various elements within the data processing apparatus are formed into pseudo queue entries, and placed within the statistics input queue 320. A statistics engine 315 is then arranged to periodically poll the statistics input queue 320 in order to pop pseudo queue pointers from the queue, and as each queue pointer is popped from the queue, the statistics engine 315 updates the system processor memory via the PCI bus.

The system processor 195 can output commands to the Trinity modems 250, 255, and retrieve status back from them. When the system processor 195 wishes to issue a command, it obtains an available buffer from the buffer RAM 115, builds up the command in the buffer, and then places on a COMSTA command queue (not shown) a queue pointer associated with that buffer entry.

The COMSTA logic 170 can then retrieve each queue pointer from its associated command queue, can retrieve the command from the associated buffer and output that command to the Trinity modems 250, 255. In a similar manner, when status information is received by the COMSTA logic 170 from the modems, that status information can be placed within an available buffer of the buffer RAM 115, and an associated queue pointer placed in a COMSTA status queue (not shown), from where those queue pointers will be retrieved by the system processor 195. The system processor can then retrieve the status information from the associated buffer 115. This approach enables the same basic mechanism to be used for the handling of such commands and status as is used for the actual transmission of call data through the data processing apparatus. Further details of the operation of the system processor and the COMSTA logic will be provided later with reference to FIGS. 10 and 11.

Situations may occur where an individual data packet needs to be broadcast to multiple destinations. In accordance with one embodiment of the present invention, such broadcasting of data packets is managed in a very efficient manner, since the data packet is stored once in a particular buffer, and a queue pointer is then generated for each destination, each queue pointer containing a pointer to that buffer. Hence, whilst multiple queue pointers are distributed between the various processing elements of the data processing apparatus, the data packet is not, and instead the data packet is stored once within a single buffer. Each associated queue pointer has an attribute bit set to indicate that it is one of multiple queue pointers for the buffer, and within the control information field 420 of the buffer, a value is set to indicate the number of associated queue pointers for that buffer. The setting of this value is performed by the processing element responsible for establishing the multiple queue pointers, for example the NIOS 140 or the system processor 195. When a processing element has finished using one of these associated queue pointers, that processing element is operable to place the queue pointer on an input connection queue for the MultiQ engine 175 rather than returning it directly to the free list. The MultiQ engine is operable to retrieve the queue pointer from that queue, and from the queue pointer identify the buffer number. The MultiQ engine 175 is then arranged to retrieve from the control information field 420 of the buffer the value indicating the number of associated queue pointers, and to decrement that number, whereafter the decremented number is written back to the control information field 420.

If the decremented number is zero, then this indicates that all of the queue pointers associated with that buffer have now been processed, and hence the MultiQ engine 175 is arranged in that instance to cause the buffer to be returned to the free list by issuance of the appropriate queue command to the queue controller 125. However, if the decremented number is non-zero, no further action takes place.

In a typical Field Programmable Gate Array (FPGA) SoC design, unidirectional buses are typically provided for the transfer of data between different logic elements. This is due to the fact that SoC designs typically only allow one driver to be provided for each bus. This can lead to a significant amount of silicon area being dedicated to the buses interconnecting the various logic units.

Within the SoC illustrated in FIG. 1, there are a number of client/server systems incorporated therein. For example, the buffer system 105 acts as a server for a variety of clients, including the Ethernet receive logic 210, the Ethernet transmit logic 290, the NIOS 140, the transmit logic 160, the receive logic 165, the MultiQ engine 175, the COMSTA logic 170, etc. Similarly, the queue system 120 acts as a server system having a variety of clients, including the Ethernet receive logic 210, the Ethernet transmit logic 290, the NIOS 140, the transmit logic 160, the receive logic 165, the MultiQ 175, The COMSTA logic 170, etc.

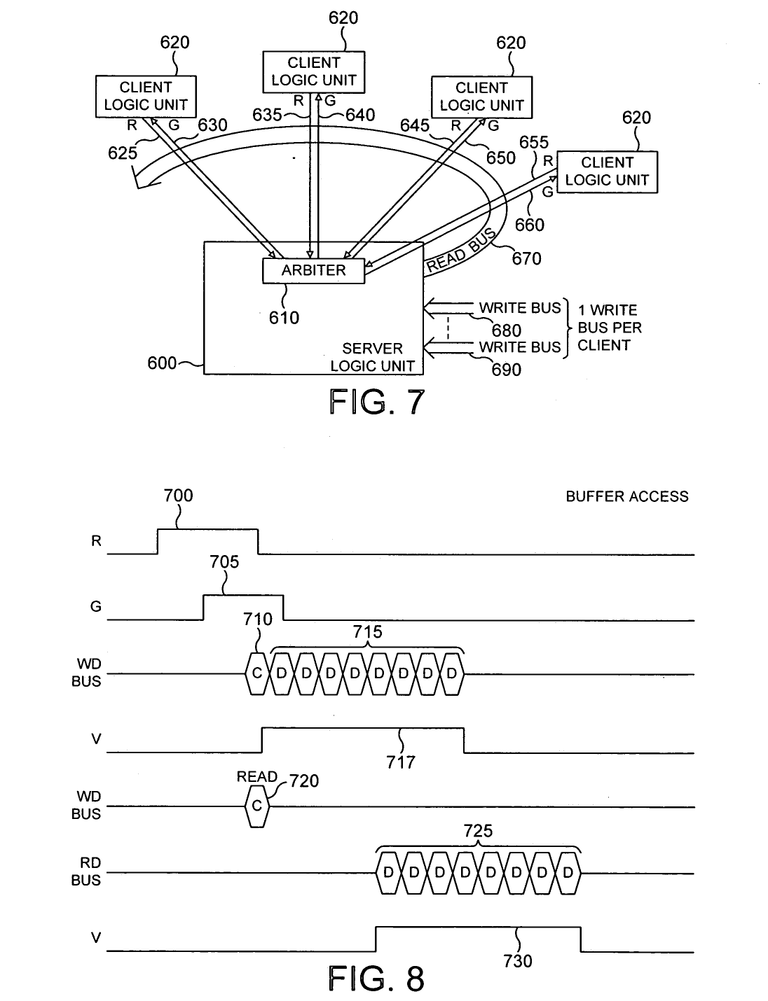

Hence, in accordance with embodiments of the present invention, a number of client-server architectures are embodied in a SoC design. In such an architecture, data needs to be able to input into the server logic unit from each client logic unit, the server logic unit needs to be able to issue data to each of the client logic units, and each client logic unit needs to be able to issue commands to the server logic unit. Using a typical SoC design approach, this would require each of the input buses from the client logic units to the server logic unit to have a width sufficient not only to carry the input data traffic but also to carry the commands to the server logic unit, resulting in a large amount of silicon area being needed for these data buses. However, in one embodiment of the present invention, this width requirement is alleviated through use of the approach illustrated in FIG. 7.

As shown in FIG. 7, the server logic unit 600 (which for example may be the buffer system 105 or the queue system 120) includes an arbiter 610 which is arranged to receive request signals from the various client logic units 620 over corresponding request paths 625, 635, 645, 655 when those clients wish to obtain a service from the server logic unit . Hence, if a client logic unit 620 wishes to access the server logic unit, for example to write data to the server logic unit, or read data from the server logic unit, it issues a request signal over its corresponding request path. The arbiter 610 is arranged to process the various request signals received, and in the event of more than one request signal being received, to arbitrate between them in order to issue a grant signal to only one client logic unit at a time over corresponding grant paths 630, 640, 650, 660.

Each client logic unit is operable in reply to a grant signal to issue a command to the server logic unit, along with any associated input data, such command and input data being routed to the server logic by a corresponding write bus 680, 690 (also referred to herein as an input bus). In the embodiment illustrated in FIG. 7, there is one write bus for each client logic unit. To reduce the width required for each bus, the client logic unit is operable to multiplex the command with the input data on the associated unidirectional write bus 680, 690.

The server logic unit is then operable to output onto a read bus 670 (also referred to herein as an output bus) result data resulting from execution of the service. Since the server logic unit will only process one command at a time, a single read bus 670 is sufficient, and only the client logic unit 620 which has been issued a grant signal will then read the data from the read bus 670.

FIG. 8 is a timing diagram illustrating how a buffer access takes place using the architecture of FIG. 7. In this example, the server logic unit 600 is the buffer system 105. Firstly, the client logic unit 620 issues a request signal 700 over its request line, and at some point will then receive over its grant line a grant signal 705 from the arbiter 610. If the client logic unit 620 wishes to write to a buffer, it will then issue onto its write bus the corresponding buffer command 710, followed by the data 715 to be written to the buffer. When the data is output, a valid signal 717 will be issued to indicate that the data on the write bus is valid. As can be seen from FIG. 8, the 32-bit buffer command is followed by 8 32-bit blocks of data 715. In the embodiment envisaged, the bus width is 32 bits and the buffer is arranged to store eight words (i.e. 8 32-bit blocks) at a time, since this is more efficient than storing one word at a time.

In the event that the client logic unit 620 wishes to read data from a buffer, it will instead issue the relevant buffer command 720 on its write bus, and at some subsequent point the buffer system will output on the read bus 670 the data 725. When the data is output on the read bus, a valid signal 730 will be issued to indicate to the client logic unit 620 that the read bus contains valid data.

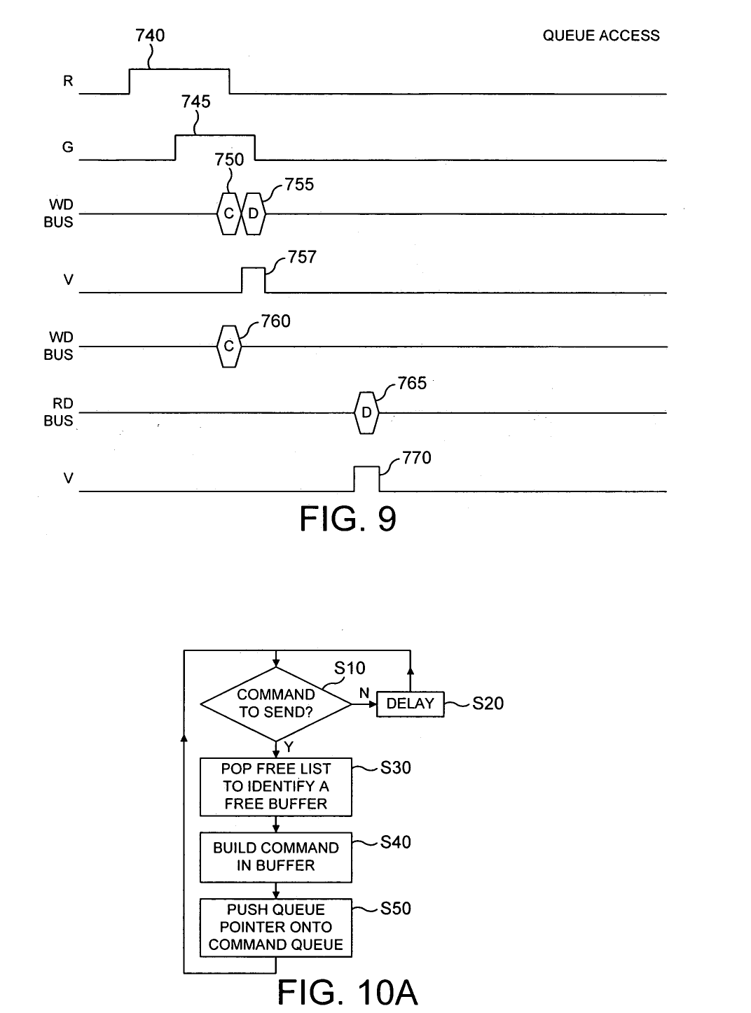

FIG. 9 shows a similar diagram for a queue access. In this example, the server logic unit 600 is the queue system 120. Again, the client logic unit 620 will issue a request signal 740 to the arbiter 610, and at some subsequent point receive a grant signal 745. If the client logic unit wishes to push a queue pointer onto a queue, then it will issue onto its write bus the appropriate queue command 750, followed by the queue pointer 755. When the queue pointer data 755 is output, a valid signal 757 will be issued to indicate that the data on the write bus is valid. If instead the client logic unit 620 wishes to pop a queue pointer from the queue, then it will instead issue the relevant queue command 760 onto its write bus, and subsequently the queue system 120 will output the queue pointer 765 onto the read bus 670. At this time, the valid signal 770 will be asserted to inform the client logic unit 620 that valid data is present on the read bus 670.

The system processor 195 provides a number of management and control functions such as the collection of status information associated with elements of the central terminal 10. In one embodiment, the system processor 195 is provided externally to, and is coupled by a bus to, the SoC.

The SoC and modems 185 operate in a synchronous manner, with reference to a common clock signal. The data passed between the modems 185 and the SoC is in the form of a synchronous data stream of data packets, each data packet occupying a particular time-slot in the data stream. By operating in a synchronous manner, the performance of the telecommunications system can be predicted and predetermined QOS levels provided. Failure to process the synchronous data stream of data packets passed between the modems 185 and the SoC can have an adverse effect on the support of calls between the CT and STs.

It will be appreciated that a finite bandwidth exists between the modems 185 and the SoC. In order to maximise bandwidth available to support uplink and downlink radio traffic between the CT and STs it is necessary to maximise the bandwidth available for data packets associated with this radio traffic. The bandwidth is varied by reducing or increasing the number of time-slots available to elements of the CT and STs and hence the frequency with which those elements may transmit data packets. Any reduction in the bandwidth for uplink and downlink radio traffic can result in insufficient data packets being provided to the RF combiner 190 or in insufficient data packets being received by the receive engine 260 which will have an adverse effect on the support of calls between the CT and STs.

To ensure that sufficient bandwidth exists to support the radio traffic, the amount of bandwidth available to any particular element of the CT and its relative priority is controlled using two techniques, the parameters of which are set by the system processor 195.

Firstly, a number of elements of the SoC, such as the ComSta logic unit 170, are arranged to remain in an idle state until activated by a ‘slow pole’ signal. Each slow pole signal is generated by a central resource for each of the number of elements of the SoC. On receipt of the slow pole signal, the element will complete one or more processing steps which may require use of the synchronous data stream and will then return to an idle state. Accordingly, the relative frequency of the slow pole signals can be set to adjust the bandwidth available to each element and its relative priority.

The second technique involves limiting the number of entries available in each queue to be processed by different elements. The number of entries is limited to ensure that once an element has received a slow pole signal and is no longer idle, the subsequent amount of bandwidth it may use is limited to that required to service entries plus any other functions that may need to be performed.

For example, the slow pole signal for the transmit logic 160 is generated at a frequency many times higher than the slow pole signal for the ComSta logic unit 170. Also, the number of entries in the queues associated with the transmit logic 160 is set to be many times higher than the number of entries in the queues associated with the ComSta logic unit 170. Accordingly, data packets to be transmitted by the transmit logic 160 are effectively prioritised over data packets to be transmitted by the ComSta logic unit 170 and the bandwidth available to the transmit logic 160 will be higher than that available to the ComSta logic unit 170.

Whilst in preferred embodiments, the frequency of the slow pole signals and the number of entries in queue are pre-set at system level, it will be appreciated that these parameters could instead by adjusted by the system processor 195 dynamically.

The system processor 195 is arranged to issue commands. The commands control the operation of the modems 185 and/or other elements of the CT. Such commands may on occasion seek status information from the modems 185 and/or other elements of the CT. However, such commands may not necessarily result status information being generated. Also, the modems 185 and/or other elements of the CT may be arranged to automatically generate status information either periodically or on the occurrence of a particular event. On occasion, the status information may be generated in response to a command.

The system processor 195 operates independently of the SoC and is not arranged to be synchronised with the operation of the modems 185 and other elements of the CT and, hence, the issue of these commands occurs in a generally asynchronous manner with respect to the operation of the modems 185 and other elements of the CT. Whilst the system processor 195 could have been provided with dedicated paths between the system processor 195 and the modems 185 to deal with these asynchronous events, the routing techniques utilised by the SoC described above are used instead to route the commands to the ComSta logic unit 170 and then on to the modems 185 via the arbiter 180. By routing the commands in this way, no additional infrastructure is required and the operation of the modems 185 can be decoupled from the occurrence of the asynchronous commands and hence the servicing of these commands can be controlled in order to reduce their performance impact on the operation of the modems 185. Equally, any status information generated is retrieved from the modems 185 via the arbiter 180 by the ComSta logic unit 170 and then routed using the routing techniques utilised by the SoC to the system processor 195. Hence, it will be appreciated that using this technique, these asynchronous commands can be transmitted in the synchronous data stream between the SoC and the modems 185.

The operation of the system processor 195 when issuing, for example, a command will now be described in more detail with reference to FIG. 10A.

The system processor 195 will at step S10 determine whether there is a command to be sent. If no command is to be sent then following a delay at step S20 the system processor 195 will again determine whether there is a command to be sent. This loop continues until a command is to be sent. If a command is to be sent then the system processor 195 will establish whether or not the maximum number of entries in the command queue has been exceeded. If the maximum number of entries has been exceeded because the commands have not yet been serviced by the ComSta logic unit 160, then following a delay at step S20 the system processor 195 will again determine whether there is a command to be sent and if the maximum number of entries have been exceeded. This loop continues until a command is to be generated and the number of entries in the command queue is not exceeded and processing proceeds to step S30.

At step S30, a queue command is sent to the queue controller 125 in order to pop the free list queue 135, as a result of which a queue pointer will be retrieved identifying a free buffer within the buffer memory 115.

Thereafter, at step S40, a buffer command will be issued by the system processor 195 to the buffer controller 110, to cause command data to be built and stored in the identified buffer within the buffer memory 115. The command data will identify, for example, the target modem to be interrogated and some form operation or control function to be performed by the target modem.

At step S50, system processor 195 will then issue a further queue command to the queue controller 125 to cause a queue pointer identifying the buffer location together with its packet length to be pushed onto a command queue for commands destined for the ComSta logic unit 170. Processing returns to step S10.

The operation of the ComSta logic unit 170 will now be described in more detail with reference to FIG. 10B.

The ComSta logic unit 170 remains in an idle state until it is activated by a slow pole signal. Hence, at step S55, the ComSta logic unit 170 checks whether the slow pole signal has been received, if not then the ComSta logic unit 170 remains idle and processing returns following a delay at step S57 to step S55. Once the slow pole signal is received then the ComSta logic unit 170 is activated and processing proceeds to step S60.

At step S60, the ComSta logic unit 170 polls the command queue by issuing the appropriate queue commands to the queue controller 125 seeking to pop queue pointers from the command queue. If no command is present on the command queue then the ComSta logic unit 170 will determine whether there is any status information to be received and processing proceeds to step S150 (shown in FIG. 11A). If a command is present on the command queue then processing proceeds to step S80.

At step S80, once a queue pointer is popped from the command queue, the ComSta logic unit 170 will read the appropriate fields of the command data residing in the buffer (such as, for example, the header) to identify which modem the command is intended for. The ComSta logic unit 170 will request that the arbiter 180 grants the ComSta logic unit 170 access to that modem over the bus between the SoC and the modems 185. Once access has been granted, the status of a command flag in the modem memory is checked and the bus is then released. The command flag provides an indication of whether or not the modem is currently servicing an earlier command.

At step S90, it is determined whether or not the command flag is set. If the command flag is not false (i.e. it is set, indicating that the modem is currently servicing an earlier command) then processing proceeds to step S100 to await the issue of a further slow pole signal. After a further slow pole signal is received, processing returns to step S80. If the command flag is false (i.e. it is cleared, indicating that the modem is not currently servicing an earlier command) then processing proceeds to step S110.

At step S110, the contents of the buffer identified by the queue pointer in the command queue will be read. At step S120, the ComSta logic unit 170 will request access to the bus and, once granted, the command is written into the modem memory and the bus is then released. At step S130 the ComSta logic unit 170 will request access to the bus and, once granted, the command flag for that modem is set to indicate that the modem is currently servicing a command and the bus is then released. At step S140, the buffer number is then pushed back onto the free list by issuance of the appropriate queue command to the queue controller 125 and processing returns to step S60 to determine whether there is a farther command to be sent by determining whether there are any other entries in the command queue. The ComSta logic unit 160 is able to service commands in the command queue at a rate which is much faster than the system processor 195 is able to write to the command queue. Hence, the ComSta logic unit 160 will quickly service these commands and then proceed step S150 to determine whether there is any status information to be collected from the modems.

The modem will respond to the command in its memory. Once a command has been serviced by the modem then the command flag will be set to false (i.e. cleared to indicate that the modem is not currently servicing a command).

When the modem generates status information a status flag will be set to true (i.e. set to indicate that the modem has status information for the ComSta logic unit 170). It will be appreciated that status information generated by the modems will not necessarily have directly resulted from a command just provided by the ComSta logic unit 170. Indeed, the modems will take typically an indeterminate time to respond to commands. Also, the modems will take typically an indeterminate time to generate status information.

The operation of the ComSta logic unit 170 when retrieving, for example, status information will now be described in more detail with reference to FIG. 11A.

The ComSta logic unit 170 will at step S150 select a modem. The selection is based upon a simple sequential selection of each of the modems 185 in turn. However, it will be appreciated that the selection could be based upon some other selection criteria. Following the modem selection processing proceeds to step S160.

At step S160, the ComSta logic unit 170 will request that the arbiter 180 grants the ComSta logic unit 170 access to the modem over the bus between the SoC and the modems 185. Once access has been granted, the status of a status flag in the modem memory is checked and the bus is then released. The status flag provides an indication of whether or not the modem has status information for the ComSta logic unit 170.

At step S170, it is determined whether or not the status flag is true. If the status flag is false (i.e. it is cleared, indicating that the modem currently has no status information for the ComSta logic unit 170) then at step S175 the ComSta logic unit 170 determines whether all the modems have been checked. If not all the modems have been checked then processing returns back to step S150 where a different modem may be chosen. If all the modems have been checked then processing returns to step S55. If at step S170, it is determined that the status flag is true (i.e. it is set, indicating that the modem has status information) then processing proceeds to step S190.

At step S190, a queue command is sent to the queue controller 125 in order to pop the free list queue 135, as a result of which a queue pointer will be retrieved identifying a free buffer within the buffer memory 115.

Thereafter, at step S200, a buffer command will be issued by the ComSta logic unit 170 to the buffer controller 110, to cause the header data to be formatted to include an indication of the modem with which the status information is associated to be stored in the identified buffer within the buffer memory 115. At step 210, the ComSta logic unit 170 will request access to the bus and, once granted, the status information is collected from the modem and at step S220 this status information (along with the header) is copied to the identified buffer within the buffer memory 115 and the bus is then released.

At step 230, the ComSta logic unit 170 will request access to the bus and, once granted, the status flag in the modem is reset to false (i.e. is cleared to indicate that the status information has been collected) and the bus is then released.

At step S240, the ComSta logic unit 170 will then issue a queue command to the queue controller 125 to cause a queue pointer identifying the buffer location together with its packet length to be pushed onto a status queue for status information destined for the system processor 195.

At step S245, the ComSta logic unit 170 determines whether all the modems 185 have been checked for status information. If not all of the modems 185 have been checked then processing returns to step S150. If all of the modems 185 have been checked then processing returns to step S55.

The operation of the system processor 195 when retrieving, for example, status information will now be described in more detail with reference to FIG. 11B.

At step 250, the system processor 195 polls the status queue by issuing the appropriate queue commands to the queue controller 125 seeking to pop queue pointers from that queue. If no status information is present on the queue then following a delay at step S260 the system processor 195 will again determine whether there is status information to be received. This loop continues until status information is received and processing proceeds to step S270.

At step S270, the buffer will be identified from the queue pointer and, at step S280, the status information within that buffer is requested from the buffer memory 115.

At step S290, the status information from the buffer is processed and typically copied to the memory of the system processor 195.

At step S300 the buffer number is then pushed back onto the free list by issuance of the appropriate queue command to the queue controller 125 and processing returns to step S250 to await the next status information.

Hence, in summary, when the system processor 195 issues a command, the command is built in a buffer and a pointer is pushed onto a command queue associated with the ComSta logic unit 170. The ComSta logic unit 170 will remain inactive until the slow pole signal is received. On receipt of the slow pole signal, the ComSta logic unit 170 becomes active and will interrogate the command queue to determine whether there are any commands to be sent to the modems. Any commands will be sent to the appropriate modems for execution and the corresponding pointed removed from the command queue. Once all the commands have been sent or if no commands are to be sent then the ComSta logic unit 170 will interrogate the modems to determine whether there is any status information to be sent to the system processor 195. If any status information is available then the ComSta logic unit 170 will collect the status information from that modem, store that status information in a buffer and a pointer is pushed onto a status queue associated with the system processor 195. Once the status information has been collected from all the modems then the ComSta logic unit will remain idle until the next slow pole signal is received. The system processor 195 will interrogate the status queue to determine whether is any status information. The status information will be retrieved from the buffer and the corresponding pointers removed from the status queue.

As mentioned previously, this technique enables asynchronous commands, events or information to be inserted into the synchronous data stream between the SoC and the modems 185. By routing in this way, no additional infrastructure is required and the operation of the modems 185 can be decoupled from the occurrence of the asynchronous commands, events or information. Hence, the servicing of these commands, events or information can be controlled in order to reduce any negative performance impact on the operation of the modems 185.

Although a particular embodiment has been described herein, it will be apparent that the invention is not limited thereto, and that many modifications and additions thereto may be made within the scope of the invention. For example, various combinations of the features of the following dependent claims can be made with the features of the independent claims without departing from the scope of the present invention. Although a particular embodiment has been described herein, it will be apparent that the invention is not limited thereto, and that many modifications and additions thereto may be made within the scope of the invention. For example, various combinations of the features of the following dependent claims can be made with the features of the independent claims without departing from the scope of the present invention.

I claim

1. A data processing apparatus comprising:
a data processing unit operable to process data from a synchronous data stream; and
conversion logic operable to receive an asynchronous event for processing by said data processing unit, said conversion logic being further operable to create event data representing said asynchronous event for transmission in said synchronous data stream.

2. The data processing apparatus of claim 1, further comprising:
control logic operable to receive and store data for subsequent transmission in said synchronous data stream, said conversion logic being operable to provide said event data to said control logic for subsequent transmission in said synchronous data stream.

3. The data processing apparatus of claim 2, wherein said control logic has buffer logic operable to store synchronous data representing synchronous events and to store said event data.

4. The data processing apparatus of claim 3, wherein said control logic has queue logic operable to provide a plurality of queues containing a number of queue pointers identifying locations of said data stored in said buffer logic.

5. The data processing apparatus of claim 4, wherein at least one queue is provided containing pointers to said synchronous data and at least one further queue is provided containing pointers to said event data.

6. The data processing apparatus of claim 5, wherein said synchronous data is attributed a higher priority than said event data.

7. The data processing apparatus of claim 6, further comprising interface logic operable to retrieve data from said control logic for transmission to said data processing unit in said synchronous data stream.

8. The data processing apparatus of claim 7, wherein said interface logic is operable to transmit data in said synchronous data stream having regard to said priority attributed to said data.

9. The data processing apparatus of claim 8, wherein said interface logic comprises a first element operable to transmit said synchronous data in said synchronous data stream and a second element operable to transmit said event data in said synchronous data stream.

10. The data processing apparatus of claim 9, wherein said first element is operable to transmit said synchronous data in said synchronous data stream by polling said at least one queue to retrieve a queue pointer and transmitting said synchronous data stored in said buffer logic at a location indicated by said queue pointer and said second element is operable to transmit said event data in said synchronous data stream by polling said at one further queue to retrieve a queue pointer and transmitting said event data stored in said buffer at a location indicated by said queue pointer.

11. The data processing apparatus of claim 10, wherein a first rate of polling by said first element and a second rate of polling by said second element is set in dependence on said priority attributed to said synchronous data and said event data.

12. The data processing apparatus of claim 11, wherein said synchronous data stream is operable to support transmission by only one element at any one time.

13. The data processing apparatus of claim 12, wherein each element is operable to generate a request when seeking to transmit data in said synchronous data stream and said data processing apparatus further comprises an arbiter operable to receive said requests and to grant access to transmit in said synchronous data stream to one of said elements in response to said requests.

14. The data processing apparatus of claim 1, wherein said data processing unit is a modem.

15. The data processing apparatus of claim 1, wherein said conversion logic comprises a processor operable to generate said asynchronous event.

16. The data processing apparatus of claim 3, wherein said synchronous data and said event data each comprise data packets and said control logic comprises
a plurality of buffers, each buffer being operable to store a data packet to be transmitted in said synchronous data stream;
a connection queue associated with said synchronous data stream, said connection queue being operable to store one or more queue pointers, each queue pointer being associated with a data packet by providing an identifier for the buffer containing the data packet; and
transmission logic responsive to said connection queue to transmit data packets in said synchronous data stream.

17. The data processing apparatus of claim 16, wherein each buffer is operable to store a data packet and one or more control fields for storing control information relating to that data packet.

18. The data processing apparatus of claim 17, wherein a plurality of data processing units are operable to process data from the synchronous data stream and said data packet includes a header portion comprising an indication of which of said plurality of data processing units is to process that data packet.

19. The data processing apparatus of claim 1, wherein the asynchronous event is a command for a data processing unit.

20. In a data processing apparatus comprising a data processing unit operable to process data from a synchronous data stream, a method of transmitting asynchronous events, said method comprising the steps of:
receiving an asynchronous event for processing by said data processing unit; and
creating event data representing said asynchronous event for transmission in said synchronous data stream.

21. The method of claim 20, further comprising the steps of:
receiving and storing, in control logic, data for subsequent transmission in said synchronous data stream; and
providing, to said control logic, said event data for subsequent transmission in said synchronous data stream.

22. The method of claim 21, further comprising the step of:
storing, in buffer logic of said control logic, synchronous data representing synchronous events and storing, in said buffer logic, said event data.

23. The method of claim 22, further comprising the step of:
providing, in queue logic, a plurality of queues containing a number of queue pointers identifying locations of said data stored in said buffer logic.

24. The method of claim 23, wherein the step of providing a plurality of queues comprises the steps of:
providing at least one queue containing pointers to said synchronous data; and
providing at least one further queue containing pointers to said event data.

25. The method of claim 24, further comprising the step of:
attributing a higher priority to said synchronous data than said event data.

26. The method of claim 25, further comprising the step of:
retrieving data from said control logic for transmission to said data processing unit in said synchronous data stream.

27. The method of claim 26, further comprising the step of:
transmitting data in said synchronous data stream having regard to said priority attributed to said data.

28. The method of claim 27, wherein the step of transmitting data further comprises the steps of:
transmitting, using a first element, said synchronous data in said synchronous data stream; and
transmitting, using a second element, said event data in said synchronous data stream.

29. The method of claim 28, wherein said step of transmitting said synchronous data further comprises the steps of:
polling said at least one queue to retrieve a queue pointer; and
transmitting said synchronous data stored in said buffer logic at a location indicated by said queue pointer and said step of transmitting said event data further comprises the steps of:
polling said at one further queue to retrieve a queue pointer; and
transmitting said event data stored in said buffer at a location indicated by said queue pointer.

30. The method of claim 29, further comprising the step of:
setting a first rate of polling by said first element and a second rate of polling by said second element in dependence on said priority attributed to said synchronous data and said event data.

31. The method of claim 30, wherein said synchronous data stream is operable to support transmission by only one element at any one time.

32. The method of claim 31, further comprising the steps of:
generating, in each element, a request when seeking to transmit data in said synchronous data stream;
receiving, in an arbiter, said requests; and
granting access to transmit in said synchronous data stream to one of said elements in response to said requests.

33. The method of claim 20, wherein said data processing unit is a modem.

34. The method of claim 20, further comprising the step of employing a processor to generate said asynchronous event.

35. The method of claim 21, wherein said data and said event data each comprise data packets, said method further comprising the steps of:
storing within a buffer a data packet to be transmitted in said synchronous data stream;
providing a connection queue associated with said synchronous data stream, said connection queue being operable to store one or more queue pointers;
generating a queue pointer associated with said data packet by providing an identifier for the buffer containing the data packet;
placing that queue pointer in said connection queue; and
providing transmission logic responsive to said connection queue to transmit data packets in said synchronous data stream.

36. The method of claim 35, wherein the step of storing within a buffer comprises storing a data packet and one or more control fields providing control information relating to that data packet.

37. The method of claim 36, wherein a plurality of data processing units are operable to process data from the synchronous data stream and said data packet includes a header portion comprising an indication of which of said plurality of data processing units is to process that data packet.

38. The method of claim 20, wherein said asynchronous event is a command for a data processing unit.
